(19) United States
(12) Patent Application Publication
(10) Pub. No.: US 2014/0331924 A1
(43) Pub. Date: Nov. 13, 2014

(54) HOLDER FOR SUPPORTING WORKPIECES IN A DIP BATH

(71) Applicant: Josep Valls BALAGUE, Alella (ES)

(72) Inventor: Josep Valls BALAGUE, Alella (ES)

(21) Appl. No.: 14/274,088

(22) Filed: May 9, 2014

(30) Foreign Application Priority Data
May 10, 2013 (EP) 13167348.5

(51) Int. Cl. B05C 13/02

(52) U.S. Cl. CPC B05C 13/025
USPC 118/500

(57) ABSTRACT

A workpiece holder for securing workpieces in a dip bath has an open generally rectangular metal frame having opposite sides. An array of at least four metal rods extending between the opposite sides forms a guide track adapted to receive and hold a row of the workpieces in contact with one another. One of the sides is formed in alignment with the track with a fill hole through which the workpieces may pass to move into and out of the track.

### FIELD OF THE INVENTION

The present invention relates to a holder for supporting workpieces in a dip bath. More particularly this invention relates to metallic workpieces and an anodizing bath

### BACKGROUND OF THE INVENTION

Small parts, for example caps, sleeves, end rings, valve disks and the like with surfaces are finished in dipping treatments. Other workpieces also commonly referred to as ferrules and used for example as decorative functional parts for dosing heads on aerosol containers and as caps for containers of cosmetic or pharmaceutical products are treated in this manner.

The workpiece holder is used for securing especially metallic workpieces that are immersed in a dip bath for surface refinement and allows for electrochemical surface treatment, especially via anodic oxidation of the workpiece surface. For the workpiece to be effective as a anode in an anodizing bath a closed electric circuit between the workpieces and the anode terminal connected to the workpiece holder must be secured.

A workpiece holder equipped with a plurality of fingers made of sheet metal allowing for elastic deformation for securing workpieces in a dip bath is well known. The workpieces are attached to the fingers so that a defined electric contact is secured by the connection. The surfaces of the workpieces finished via dipping treatments are of high quality if the workpieces are individually fastened to the projecting fingers of a workpiece holder. However, only a limited number of workpieces can be fastened to a workpiece holder of the described design. The placement density, i.e. the number of workpieces relative to the dimensions of the workpiece holder, is rather small and limits the capacity and efficiency of the dipping treatment.

It is also known to use baskets filled with the workpieces and immersed in the dipping paths for surface treatment. The workpieces are dumped into the baskets. For electrochemical surface treatments the bulk material within the baskets is put under mechanical pressure via a clamping device to secure sufficient electric contact for the workpieces. However, the electric connection is not defined and varies from workpiece to workpiece. In addition, there is the danger that the workpieces may be damaged mechanically during the loading process. As a result, a significant degradation in the quality of surface treatments must be accepted if baskets containing the workpieces as bulk loads are used. A significant part of the workpieces must be sorted out, deanodized and finally they must be retreated.

U.S. Pat. No. 4,391,696 describes a workpiece holder for holding a plurality of styli in a high density configuration during processing. This holder comprises a plurality of slots forming guide tracks that extend from one side of the holder to an opposite side of the holder for receiving workpieces. The slots each have a pair of longitudinal sides parallel to each other and separated by a distance greater than the length of a stylus but less than twice the stylus diameter. This causes the styli to arrange themselves side by side in two rows oriented along the slot.

### OBJECTS OF THE INVENTION

It is therefore an object of the present invention to provide an improved holder for supporting workpieces in a dip bath.

Another object is the provision of such an improved holder for supporting workpieces in a dip bath that overcomes the above-given disadvantages, in particular in which, relative to the dimensions of the workpiece holder, a large number of workpieces with a defined electric connection for electrochemical surface treatment can be secured.

The workpiece holder must also be designed in such a way that the workpieces anodized with this holder are of higher surface quality than workpieces exposed to a dipping treatment as bulk load in a basket. The quality of the surfaces should be close to the surface quality achieved when the workpieces are individually secured to projecting fingers of a workpiece holder.

### SUMMARY OF THE INVENTION

A workpiece holder for securing workpieces in a dip bath has according to the invention an open metal frame having opposite sides. At least four metal rods extending between the opposite sides form a guide track adapted to receive and hold a row of the workpieces in contact with one another. One of the sides is formed in alignment with the track with a fill hole through which the workpieces may pass to move into and out of the track.

Thus the basic structure of the workpiece holder according to the present invention is an open and normally rectangular metal frame and guide tracks formed by straight cylindrical metal rods that extend from one side of the metal frame to the opposite side of the metal frame. Within the guide tracks the workpieces are arranged in rows. Each of the guide tracks comprises an arrangement of at least four metal rods. At least on one side the metal frame is equipped with a number of fill holes for inserting the workpieces into and removing them from the guide tracks. Within each of the guide tracks the workpieces are arranged in a row and are in contact with the flanking workpieces in the row, but not with other workpieces.

The metal rods of the guide tracks are connected to the metal frame, preferably by welds. The contact of the workpieces to the metal rods of the guide tracks and the additional contact between the workpieces within a row provides a good, defined electric connection that allows for a high quality result of the treatment in an electrochemical dip bath, especially an anodizing bath.

In comparison with the workpiece holders according to prior art in which the workpieces are individually gripped by respective sets of projecting fingers, a multiple of the number of workpieces can be secured on a workpiece holder of the same dimensions. In comparison to the use of baskets, higher surface quality can be achieved. With workpieces that are arranged in a row and therefore with a defined orientation within the guide tracks of the workpiece holder, it can further be ensured by means of a corresponding orientation of the workpiece holder that the process fluids drip off almost completely after the dipping treatment. For a surface treatment that comprises several dip baths, carry-over of process fluids between the baths can be kept minimal. The carry-over is significantly lower than the carry-over that must be accepted when the workpieces are treated in baskets. The workpiece holders can be used without problem in exchange with workpiece holders according to the prior art that have a metal frame with projecting fingers for securing the workpieces.

A plurality of guide tracks can be arranged side by side, with a small lateral spacing of a few millimeters is entirely sufficient. According to a preferred embodiment of the present invention the guide tracks are arranged in two planes, with the workpieces back-to-back within the guide tracks of the two planes. Workpieces, for example caps having an inner and an outer surface can be arranged back-to-back within the guide tracks of the two planes, that is open outward away from each other, in such a way that the outer surface of the workpieces is visible at the top and at the bottom of the metal frame. Provided the workpiece holder is lowered into and lifted out of the dip bath in a vertical orientation, the adhering process fluid can drip off unobstructed.

An advantageous design feature of the workpiece holder according to the present invention provides that the guide tracks of both planes are arranged in pairs in a workpiece support formed by two metal rods for both guide tracks. According to a preferred embodiment of the present invention an arrangement of six parallel rods is provided to form two paired guide tracks in both planes.

The fill holes in the metal frame can be blocked with a closure. Furthermore, weights or pressure springs are conveniently provided within the guide tracks to bias the row of workpieces within the guide track. With this preload a contact of all workpieces in the row can be ensured.

To stabilize the metal rods at least one cross brace that is mounted to the metal frame and connected to the metal rods is conveniently provided. The metal frame and the metal rods are conveniently made of titanium and connected by welding.

### BRIEF DESCRIPTION OF THE DRAWING

The above and other objects, features, and advantages will become more readily apparent from the following description, reference being made to the accompanying drawing in which:

FIG. 1 is a perspective view from above of a workpiece holder partially filled with workpieces for use in a dip bath;

FIG. 2 is a large-scale detail view of the closed lower end of the workpiece holder shown in FIG. 1 of the workpieces positioned in the workpiece holder;

FIG. 3 is a top view of the holder with workpieces and showing the fill holes; and

FIG. 4 is a vertical section through the holder showing the fill holes of the frame side of the workpiece holder shown in FIG. 3.

### SPECIFIC DESCRIPTION OF THE INVENTION

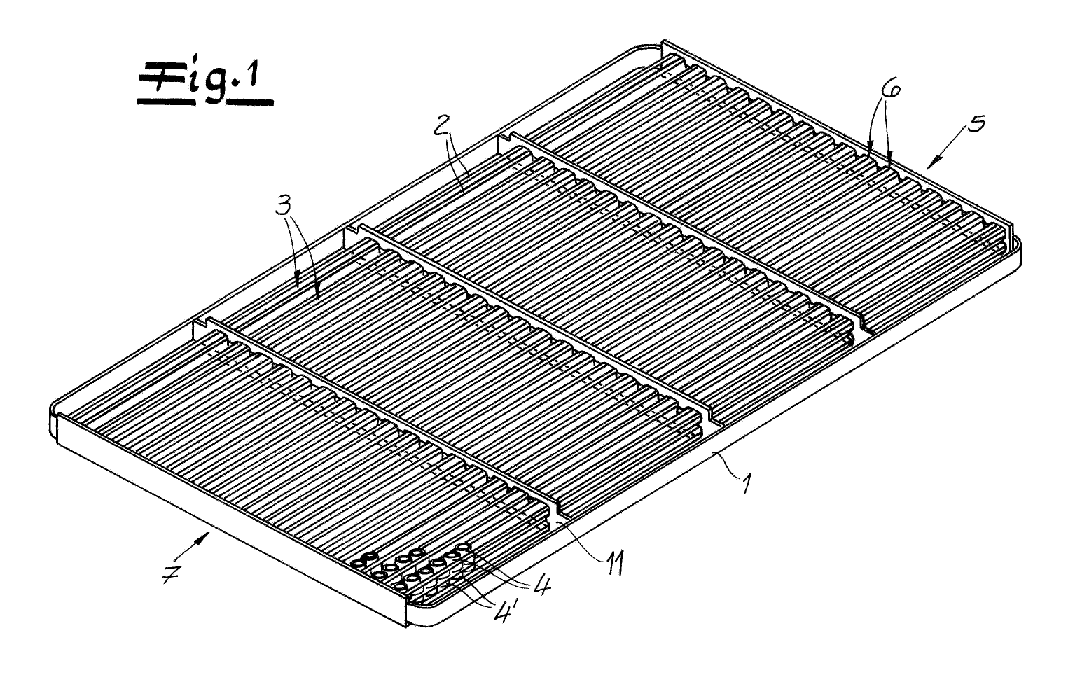

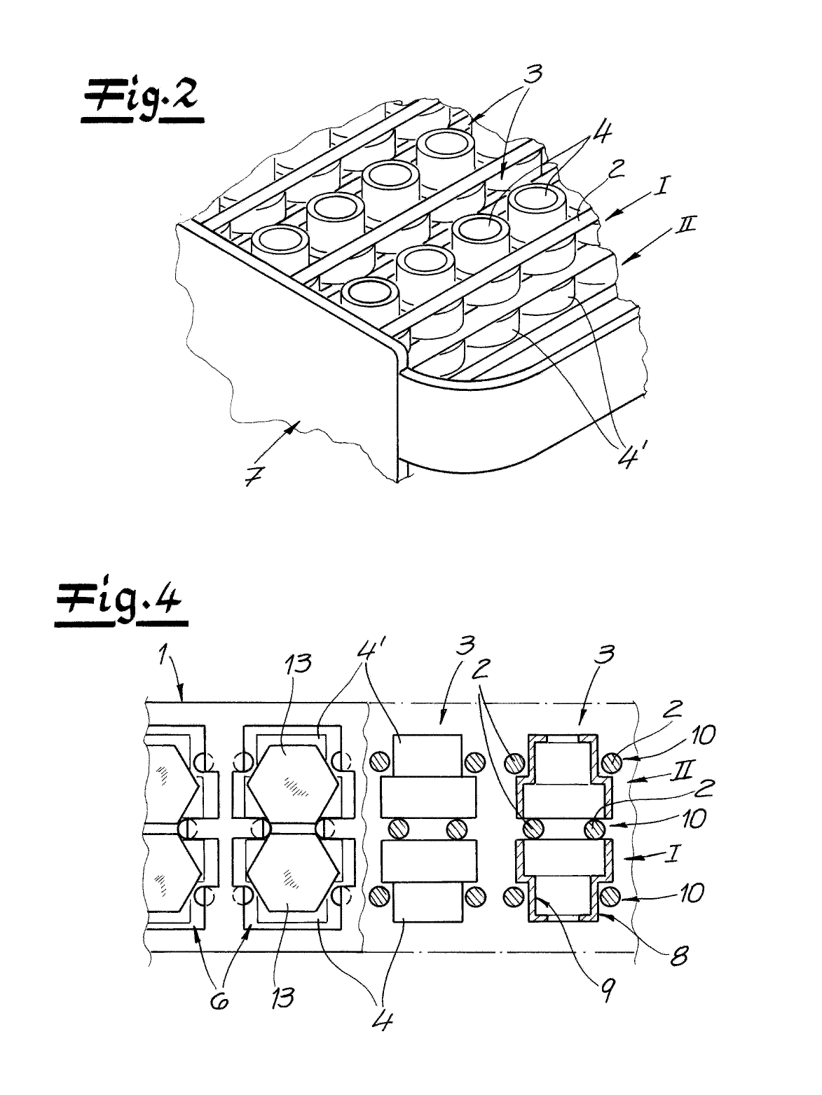

As seen in FIGS. 1-4 the workpiece holder according to the invention is used to secure workpieces 4 and 4′ in dip baths, especially in anodizing baths. The basic structure of the workpiece holder is a generally rectangular metal frame 1 and a lattice of parallel metal rods 2 that form guide tracks 3 extending from one side 5 to an opposite side 7 of the metal frame 1. The guide tracks 3 carry rows of the workpieces 4 and 4′ that are small parts, for example caps, sleeves, end rings, valve disks etc. with surfaces to be finished in a dipping treatment.

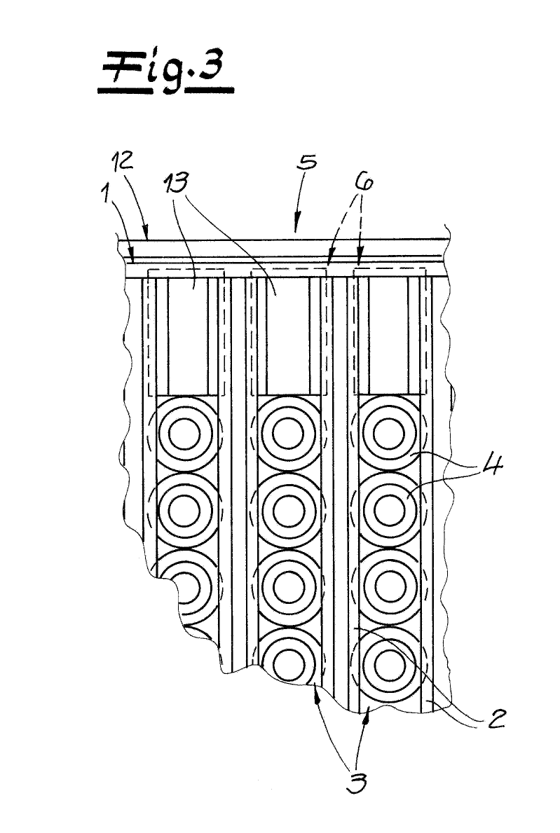

The metal frame 1 has on the one side 5 (FIG. 3) fill holes 6 of a shape slightly larger than but complementary to the workpieces 4 and 4′ for inserting the workpieces 4 into the guide tracks 3. The other side 7 of the frame 1 is closed, so the workpieces 4 and 4′ cannot move through this side 7. In the guide tracks 3 the workpieces 4 are in contact with one another and with the rods 2.

Each guide track 3 is formed by at least four metal rods 2 extending parallel to one another with as shown in FIG. 4 the two inner rods being somewhat more closely spaced than the outer rods and forming part of two separate tracks 3 so that a lower layer of the workpieces 4 lies directly below an upper layer of the workpieces 4′. Each workpiece 4 and 4′ is formed as a pair of cylindrical tubes, one of greater diameter than the other, with confronting ends connected by a planar and annular web and the outer ends of the smaller-diameter tube sections each turned in as a planar and circularly annular rim.

Thus the guide tracks 3 are in two planes I and II with the workpieces 4 and 4′ back-to-back within the guide tracks 3 of the planes I, II. The workpieces 4 and 4′, which have an outer surface 8 and an inner surface 9, are set in the guide tracks 3 of the planes I and II in a back-to-back arrangement in such a manner that the outer surfaces 9 of the workpieces 4 and 4′ are visible at the top and the bottom of the metal frame 1 (FIG. 4). In practical operation the metal frame 1 is conveniently lowered into and lifted out of the dip bath oriented vertically. Due to the orientation of the workpieces 4 ad 4′ in the guide tracks 3 the process fluid can drip off the workpiece surfaces 8 and 9 almost completely. Since the outer surfaces 8 of the workpieces 4 and 4′ are exposed, a high surface quality on the outer surfaces 8 of the workpieces 4 and 4′ can be achieved.

FIG. 4 in particular shows that the rods 2 are arrayed in three parallel but equispaced planes 10 and that the guide tracks 3 are arranged in pairs in planes I and II between the planes 10 in such a manner that two adjacent paired tracks 3 share two of the metal rods in the middle plane 10. In the embodiment shown in FIG. 4 an arrangement of six metal rods 2 is provided to form the two paired guide tracks 3 in the planes I and II.

To stabilize the metal rods 2 at least one cross brace 11 is mounted to the metal frame 1 and connected to the metal rods 3. The frame 1 and the rods 2 are preferably made of titanium and interconnected by welding.

The fill holes 6 of the metal frame 1 can be blocked with a closure 12, for example a removable flat rod. The closure 12 allows blocking of the fill holes 6. Furthermore weights 13 or pressure springs in the guide tracks 3 bias the rods against the workpieces 4 and 4′.

I claim:

1. A workpiece holder for securing workpieces in a dip bath, the holder comprising:
an open metal frame having opposite sides; and
at least four metal rods extending between the opposite sides and forming a guide track adapted to receive and hold a row of the workpieces in contact with one another, one of the sides being formed in alignment with the track with a fill hole through which the workpieces may pass to move into and out of the track.

2. The workpiece holder defined in claim 1, wherein there are more than four metal rods forming a plurality of the tracks and the one side is formed with more than one of the fill holes, each fill hole being in line with a respective one of the tracks, each track holding a respective row of the workpieces in contact with one another.

3. The workpiece holder defined in claim 2, wherein the rods and tracks are all parallel to one another.

4. The workpiece holder defined in claim 3, wherein the rods are oriented to form two parallel, planar, and adjacent arrays of the tracks, the one side being formed with two straight rows of the holes.

5. The workpiece holder defined in claim 4, wherein the workpieces and tracks are relatively oriented such that outer surfaces of the workpieces are substantially exposed.

6. The workpiece holder defined in claim 4, wherein the rods are oriented in three parallel planes including a middle plane and two outer planes and the rods of the middle plane form the tracks with the rods of the outer plane.

7. The workpiece holder defined in claim 2, further comprising:
respective closures fittable in the holes to prevent the workpieces from falling out of the tracks.

8. The workpiece holder defined in claim 2, further comprising:
biasing means urging the rods into snug engagement with the workpieces.

9. The workpiece holder defined in claim 2, further comprising:
a cross brace extending parallel to and between the sides and connected to the rods outside the tracks.

10. The workpiece holder defined in claim 2, wherein the frame and rods are of titanium.

11. The workpiece holder defined in claim 10, wherein the rods and frame are welded together.
